(19) United States
(12) Patent Application Publication
(10) Pub. No.: US 2025/0241821 A1
(43) Pub. Date: Jul. 31, 2025

(54) FASCIA GUN STORAGE DEVICE

(71) Applicant: Guangdong Okay Technology Co., Ltd., Guangdong (CN)

(72) Inventor: Rangming ZHANG, Guangdong (CN)

(21) Appl. No.: 18/904,325

(22) Filed: Oct. 2, 2024

(30) Foreign Application Priority Data
Jan. 31, 2024 (CN) 202420246351X

(51) Int. Cl. A61H 23/00; B65D 25/10

(52) U.S. Cl. CPC A61H 23/006; B65D 25/108; A61H 2201/1685

(57) ABSTRACT

A fascia gun storage devices and kits including fascia guns and such storage devices are provided. A fascia gun storage device includes a box body and a fascia gun module. The box body has a housing cavity and an installation opening communicated with the housing cavity. The housing cavity is capable of receiving at least one first massage head. The fascia gun module may include a housing and a second massage head. The second massage head is arranged protruding from the housing and detachably connected with the housing. The housing and the box body are detachably connected, so as to open or close the installation opening. When the housing closes the installation opening, the second massage head is stored in the housing cavity. This design facilitates improved protection for each massage head, allowing for convenient carrying and simplifying the use of such fascia guns.

### CROSS-REFERENCE TO RELATED APPLICATION

This application claims the benefit of priority from Chinese Patent Application No. 202420246351.X, filed on Jan. 31, 2024, the complete disclosure of which is incorporated herein by reference in its entirety for all purposes.

### TECHNICAL FIELD

This disclosure generally relates to nursing equipment, and more particularly, to a fascia gun storage device.

### BACKGROUND

A fascia gun is typically used to perform deep message by means of impact, or by slowly moving the gun on the surface of a muscle in order to impact the muscle and fascia tissue in a targeted manner. After use, an existing fascia gun is typically placed at will. The massage head is exposed to the environment, and is susceptible to collisions with other objects, resulting in damage to the massage head. In addition, since there are many different kinds of massage heads which are configured to care for different parts of the human body, it is not easy for the user to carry so many massage heads outdoors, thereby resulting in poor nursing effects when the user is outdoors.

### SUMMARY

Fascia gun storage devices and kits including a fascia gun and the storage device are provided herein.

In one aspect, a fascia gun storage device comprises a box body and a fascia gun module. The box body comprises a housing cavity and an installation opening coupled to the housing cavity. The housing cavity is configured to receive at least one first massage head. The fascia gun module comprises a housing and a second massage head. The second massage head extends from the housing and is detachably connected with the housing to open or close the installation opening, and in response to the housing closing the installation opening, the second massage head is stored in the housing cavity.

In embodiments, the box body and the housing comprise a partially smooth connection therebetween.

In embodiments, the box body includes a plurality of housing parts in the housing cavity, and the plurality of housing parts are configured to receive the first massage head and the second massage head, and define positions for the first massage head and the second massage head.

In embodiments, each of the plurality of housing parts includes a slot arranged inside the housing cavity.

In embodiments, the plurality of housing parts are arranged in sequence along a line segment.

In embodiments, in response to the housing closing the installation opening and the second massage head being received in the housing, at least one of the plurality of housing parts corresponds to a position of the second massage head to place the second massage head.

In embodiments, the box body includes a sunken platform at the installation opening, so that the housing is inserted into the box body through the installation opening, and a platform surface of the sunken platform supports the housing.

In embodiments, the fascia gun storage device further comprises a magnetic structure arranged between the box body and the housing such that the box body and the housing are magnetically attracted and attached to each other by the magnetic structure.

In embodiments, the housing is handle-shaped and one of the first massage head and the second massage head is capable of being detachably mounted on a side wall surface of the housing in a longitudinal direction of the housing. In response to the housing being connected with the box body, at least part of the side wall surface of the housing closes the installation opening.

In embodiments, a driving assembly is arranged in the housing, and the housing includes a socket communicated with an interior of the housing, so that one of the first massage head and the second massage head is capable of being inserted into the socket and detachably connected with the driving assembly. The driving assembly drives the one of the first massage head and the second massage head to reciprocate in an insertion direction.

Additional aspects and advantages of the devices described herein will be set forth in part in the following description, and in part will be obvious from the following description, or may be learned by practice of the description.

### BRIEF DESCRIPTION OF DRAWINGS

The above and/or additional aspects and advantages of this description will be more apparent from the following description of certain embodiments taken in conjunction with the accompanying drawings, in which:

FIG. 1 is a three-dimensional schematic diagram of a fascia gun storage device;

FIG. 2 is a schematic structural diagram showing a separated state of the fascia gun storage device;

FIG. 3 is an exploded view of a box body of the fascia gun storage device;

FIG. 4 is a schematic diagram showing a disassembly state of the fascia gun storage device; and

FIG. 5 is an exploded view of a fascia gun module of the fascia gun storage device.

### DETAILED DESCRIPTION

The embodiments are described in detail below, examples of which are shown in the drawings, where the same or similar reference numerals indicate the same or similar elements or elements with the same or similar functions throughout. The embodiments described below by referring to the drawings are exemplary and are only used to explain the devices herein, and cannot be understood as limitations.

It should be noted that, the orientation or positional relationships indicated by the terms “up”, “down”, “front”, “back”, “left”, “right”, “vertical”, “horizontal”, “top”, “bottom”, “inside”, “outside” and the like are orientation or positional relationships based on the accompanying drawings, which are only for convenience and simplification of the description, but are not intended to indicate or imply that the indicated device or element must have a specific orientation, be constructed and operated in a specific orientation, and thus, cannot be understood as a limitation.

The meaning of “a plurality of” refers to “one or more”, and the meaning of “multiple” refers to “more than two”. The meanings of “greater than”, “less than”, “more than”, etc., are understood as not including the indicated number. If there is a description to the first and second, it is only for the purpose of distinguishing technical features, and shall not be understood as indicating or implying relative importance, implicitly indicating the number of the indicated technical features or implicitly indicating the order of the indicated technical features.

Unless otherwise explicitly defined, words such as “connection”, “connected” and “connecting” should be understood in a broad sense, for example, a connection may be a fixed connection, a detachable connection or an integrated connection; may be a mechanical connection or an electrical connection; “A being connected to B” may be directly connected, may also be indirectly connected through an intermediate medium, and there may be a communication inside the two elements. Those skilled in the art can understand the specific meanings of the above words in the description in combination with the specific context.

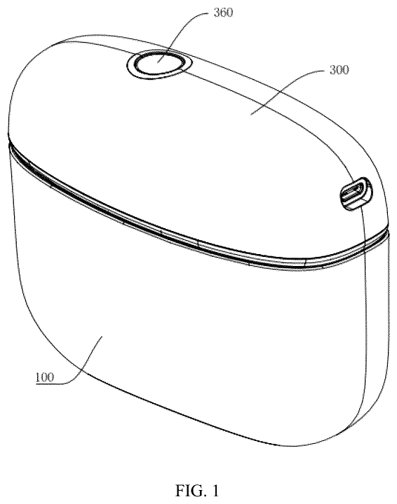

As shown in FIGS. 1-5, a fascia gun storage device includes a box body 100 and a fascia gun module 300. The box body 100 has a housing cavity 110 and an installation opening 120 coupled to the housing cavity 110. The housing cavity 110 is capable of receiving at least one first massage head 200. The fascia gun module 300 includes a housing 310 and a second massage head 320. The second massage head 320 is arranged protruding from the housing 310 and detachably connected to the housing 310. The housing 310 and the box body 100 are detachably connected so as to open or close the installation opening 120, and when the housing 310 closes the installation opening 120, the second massage head 320 is stored in the housing cavity 110.

A driving assembly 330 is arranged in the housing 310, and the housing 310 includes a socket 311 communicated with an interior of the housing 310. One of the first massage head 200 and the second massage head 320 may be inserted into the socket 311 and detachably connected with the driving assembly 330. The driving assembly 330 is capable of driving the first massage head 200 or the second massage head 320 to reciprocate in an insertion direction.

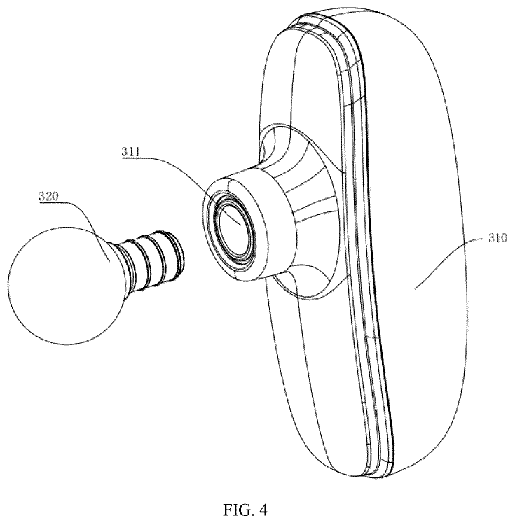

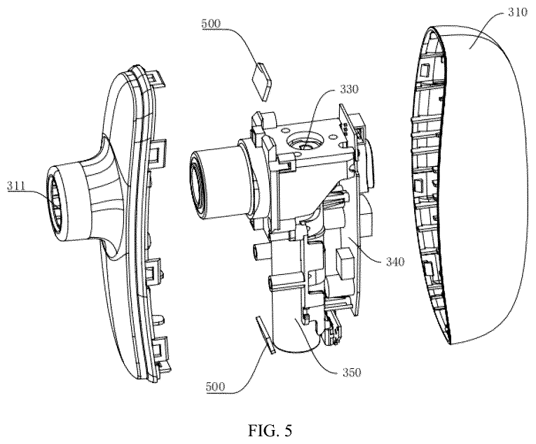

As shown in FIGS. 4 and 5, a circuit board 340 and an energy storage battery 350 are arranged in the housing 310, and a button 360 is arranged on the housing 310. The circuit board 340 is electrically connected with the driving assembly 330, the button 360 and the energy storage battery 350 respectively. A control chip and auxiliary circuits are arranged on the circuit board 340. A user may press the button 360 so that the circuit board 340 may receive a trigger signal. The trigger signal is configured to start or stop the driving assembly 330, and the energy storage battery 350 is configured to supply power to the circuit board 340 and the driving assembly 330 respectively. In some embodiments, the driving assembly 330 may include a motor, a cam and a movable sleeve. The movable sleeve may be movably arranged in the socket 311, and one of the first massage head 200 and second massage head 320 may be partially inserted in the movable sleeve. Then, the motor is connected with the cam and can drive the cam to rotate, and the cam drives the movable sleeve to move back and forth in the socket 311, thereby driving the one of the first massage head 200 and the second massage head 320 to move back and forth in the insertion direction. Other driving modes may be used to replace the driving assembly 330, which is not detailed here.

According to the fascia gun storage device, the box body 100 has the housing cavity 110, and the first massage head 200 for replacing the second massage head 320 may be received in the housing cavity 110. When needed, the first massage head 200 is capable of being taken out from the opened installation opening 120. When the user needs physical therapy, the fascia gun module 300 may be taken out from the box body 100, and the user holds the housing 310 and uses the second massage head 320 to perform physical therapy on body parts. There may be different kinds of first massage heads 200. One of the first massage heads 200 may be selected to replace the second massage head 320 according to the actual situation. After use, the massage heads 200 taken out can be put into the housing cavity 110, and the second massage head 320 can be received in the housing cavity 110 for storage after the housing 310 is connected with the box body 100 to close the installation opening 120. Such a design facilitates better protection for each massage head as compared to the existing fascia gun, allowing for convenient carrying and simplifying the use.

In some embodiments, as shown in FIG. 1, a connection between the box body 100 and the housing 310 is at least partially smooth.

When the box body 100 and the housing 310 are connected with each other, at the connection, a surface of the box body 100 is approximately flush with and joined to a surface of the housing 310, which facilitates ease of access and placement for the user, ensuring excellent sealing performance of the housing cavity 110, so that the box body 100 and the housing 310 are not easily separated due to the collision of external objects.

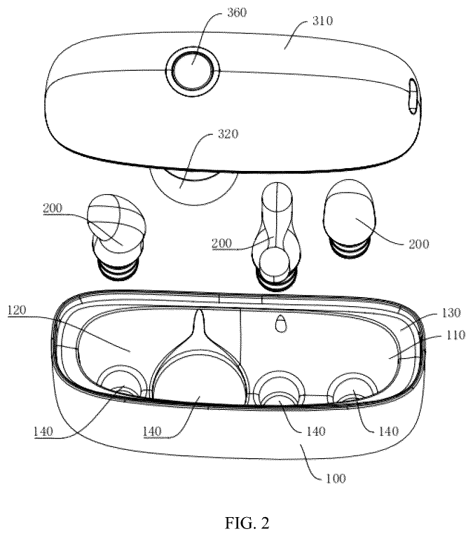

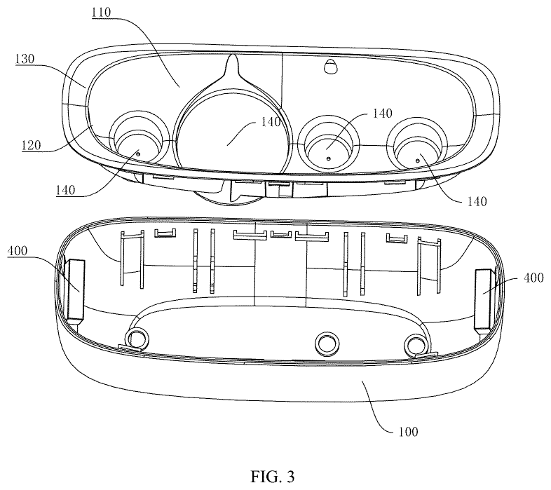

In some embodiments, as shown in FIGS. 2 and 3, the box body 100 includes a plurality of housing parts 140 in the housing cavity 110, and the housing parts 140 are configured to receive the first massage head 200 or the second massage head 320, and define positions for the first massage head 200 and the second massage head 320 respectively.

Each housing part 140 may correspondingly define a position for the first massage head 200 or the second massage head 320 in the housing cavity 110, so that the first massage head 200 and the second massage head 320 may not be scattered and collide with each other. Such an arrangement can make full use of the space in the housing cavity 110 and reduce an overall volume of the storage device.

In some embodiments, as shown in FIGS. 2 and 3, each housing part 140 has a slot arranged inside the housing cavity 110.

In some embodiments, in order to be inserted into the socket 311 and connected with the driving assembly 330, the first massage head 200 and the second massage head 320 may include a supporter including an insert. A massage piece is assembled to the supporter. The massage piece may have various shapes, such as a spherical shape, a “Y” shape, a thumb shape or the like, and the insert may be inserted into the socket 311 and connected with the driving assembly 330. The insert may also be inserted into the slot, so that a position of the insert is limited by the slot, and the installation and disassembly are simple and convenient. In some embodiments, the shape of the massage piece may match with a shape of an inner wall of the slot, and position limiting may be obtained by placing the massage piece in the slot.

In some embodiments, as shown in FIG. 4, the plurality of housing parts 140 are arranged in sequence along a line segment, so that a cross section of the housing cavity 110 may be strip-shaped, and a shape of the storage device may be flat, so as to reduce the volume as much as possible and facilitate portability.

In some embodiments, as shown in FIG. 2, when the housing 310 closes the installation opening 120 and the second massage head 320 is arranged in the housing 310, at least one of the housing parts 140 corresponds to the position of the second massage head 320 to receive the second massage head 320.

After the user finishes using the fascia gun module 300, the user does not need to separate and disassemble the second massage head 320 from the housing 310, but can directly connect the housing 310 to the box body 100, then the housing 310 closes the installation opening 120, so that the second massage head 320 may be placed in one of the housing parts 140 for storage, which is more convenient to use. When needed, the fascia gun module 300 can be used after the housing 310 is separated from the box body 100.

In some embodiments, as shown in FIGS. 2 and 3, the box body 100 includes a sunken platform 130 at the installation opening 120, so that the housing 310 is inserted into the box body 100 through the installation opening 120, and a platform surface of the sunken platform 130 supports the housing 310.

The box body 100 and the housing 310 are connected by mutual insertion, and the box body 100 includes the sunken platform 130 at the installation opening 120. After the housing 310 is inserted into the installation opening 120, the platform surface of the sunken platform 130 supports the housing 310 to limit an insertion position of the housing 310.

In some embodiments, the box body 100 and the housing 310 may be connected by means of a snap-fit connection, thread or the like.

In some embodiments, as shown in FIGS. 3 and 5, a magnetic structure is arranged between the box body 100 and the housing 310, so that the box body 100 and the housing 310 may be magnetically attracted to each other by the magnetic structure.

When the box body 100 and the housing 310 are close to each other, the magnetic structure is capable of attracting the box body 100 and the housing 310 to each other, so that the connection of the box body 100 and the housing 310 is stable and firmer, and the two are not easy to loose and separate.

As shown in FIG. 3, a plurality of first magnetic blocks 400 may be arranged inside the box body 100. As shown in FIG. 5, a plurality of second magnetic blocks 500 cooperated with the first magnetic blocks 400 may be arranged inside the housing 310. When the box body 100 and the housing 310 are close to each other, the first magnetic blocks 400 and the second magnetic blocks 500 attract to each other, so that the box body 100 and the housing 310 are firmly connected.

In some embodiments, the magnetic structure may be the first magnetic blocks 400 in the box body 100 and the housing 310 made of magnetic materials. Alternatively, the magnetic structure may be the second magnetic blocks 500 in the housing 310 and the box body 100 made of magnetic materials.

In some embodiments, as shown in FIG. 2, the housing 310 is handle-shaped, and the first massage head 200 or the second massage head 320 is detachably mounted on a side wall surface in a longitudinal direction of the housing 310. When the housing 310 is connected with the box body 100, at least part of the side wall surface of the housing 310 closes the installation opening 120.

In order to facilitate the user to hold the fascia gun module and care for a body part, the housing 310 is handle-shaped, and the first massage head 200 or the second massage head 320 is detachably mounted on the side wall surface of the housing 310. When storage is needed, the side wall surface of the housing 310 may get close to the installation opening 120 of the box body 100 and engage with the box body 100, so that the housing 310 protrudes from the box body 100 along a thickness direction of the handle shape. The housing cavity 110 in the box body 100 extends along a length direction of the housing 310 for placing the first massage head 200 and the second massage head 320, so that an overall volume of the storage device is minimized and the structure is more compact.

The fascia gun storage device has at least the following beneficial effects.

According to the fascia gun storage device, the box body has the housing cavity. The first massage head for replacing the second massage head may be placed in the housing cavity, and is capable of being taken out from the opened installation opening when needed. When a user needs physical therapy, the fascia gun module is capable of being separated from the box body, and the user holds the housing and uses the second massage head to perform physical therapy on body parts. The second massage head may be replaced by different first massage heads according to the actual situation. After use, one or more massage heads taken out are put into the housing cavity, and the second massage head can be received in the housing cavity for storage after the housing is connected with the box body to close the installation opening. Such a design facilitates better protection for each massage head, allowing for convenient carrying and simplifying the use.

The technical features of the above embodiments can be combined in any way. In order to simplify the description, not all the possible combinations of the technical features of the above embodiments are described. However, as long as there is no contradiction in the combinations of these technical features, the combinations should be considered within the scope of the description

Although some embodiments are shown and described, those having ordinary skills in the art should understand that various changes, amendments, substitutions and modifications may be made to these embodiments without departing from the principles and purposes of the description, and the scope of the description is limited by the claims and equivalents thereof.

What is claimed is:

1. A fascia gun storage device, comprising:
a box body comprising a housing cavity and an installation opening coupled to the housing cavity, wherein the housing cavity is configured to receive at least one first massage head; and
a fascia gun module comprising a housing configured to receive a second massage head extending from the housing and detachably connected with the housing, wherein the housing and the box body are detachably connected to open or close the installation opening.

2. The fascia gun storage device of claim 1, wherein, in response to the housing closing the installation opening, the second massage head is stored in the housing cavity.

3. The fascia gun storage device of claim 1, wherein a connection between the box body and the housing is at least partially smooth.

4. The fascia gun storage device of claim 1, wherein the box body comprises a plurality of housing parts in the housing cavity, and the plurality of housing parts are configured to receive the first massage head and the second massage head, and define positions for the first massage head and the second massage head.

5. The fascia gun storage device of claim 4, wherein each of the plurality of housing parts comprises a slot arranged inside the housing cavity.

6. The fascia gun storage device of claim 4, wherein the plurality of housing parts are arranged in sequence along a line segment.

7. The fascia gun storage device of claim 4, wherein in response to the housing closing the installation opening and the second massage head being received in the housing, at least one of the plurality of housing parts corresponds to a position of the second massage head to place the second massage head.

8. The fascia gun storage device of claim 1, wherein the box body comprises a sunken platform at the installation opening, so that the housing is inserted into the box body through the installation opening, and a surface of the sunken platform supports the housing.

9. The fascia gun storage device of claim 1, wherein a magnetic structure is arranged between the box body and the housing, and the box body and the housing are magnetically attracted to each other by the magnetic structure.

10. The fascia gun storage device of claim 1, wherein the housing is handle-shaped, one of the first massage head and the second massage head is capable of being detachably mounted on a side wall surface of the housing in a longitudinal direction of the housing, and in response to the housing being connected with the box body, at least part of the side wall surface of the housing closes the installation opening.

11. The fascia gun storage device of claim 1, wherein a driving assembly is arranged in the housing, and the housing comprises a socket communicated with an interior of the housing, so that one of the first massage head and the second massage head is capable of being inserted into the socket and detachably connected with the driving assembly, and the driving assembly drives the one of the first massage head and the second massage head to reciprocate in an insertion direction.

12. A kit comprising:
at least one message head; and
a storage device, comprising a box body comprising a housing cavity and an installation opening coupled to the housing cavity, wherein the housing cavity is configured to receive the at least one first massage head.

13. The kit of claim 12, further comprising a second massage head.

14. The kit of claim 13, wherein the storage device further comprises a fascia gun module comprising a housing configured to receive the second massage head such that the second massage head extends from the housing and is detachably connected with the housing.

15. The kit of claim 14, wherein the housing and the box body are detachably connected to open or close the installation opening.
